(19) United States
(12) Patent Application Publication
(10) Pub. No.: US 2006/0221786 A1
(43) Pub. Date: Oct. 5, 2006

(54) Disk apparatus and disk recording/reproducing method

(76) Inventors: Osamu Komoda, Yokohama (JP); Hiroaki Ono, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,381

(22) Filed: Mar. 6, 2006

(30) Foreign Application Priority Data
Mar. 31, 2005 (JP) 2005-100502

(51) Int. Cl. G11B 5/09

(52) U.S. Cl. 369/47.1

(57) ABSTRACT

In a disk apparatus capable of quickly recording a certain amount of information without waiting until a rotation is stabilized, a rotation control method is selected based upon the sort of optical disk, the recording format, the recording method, and the like for quickly recording a certain amount of information in a higher efficiency in view of a temporal aspect. Then, the disk apparatus records information on the optical disk, while the disk apparatus controls a rotation of the optical disk in accordance with the selected rotation control method.

### INCORPORATION BY REFERENCE

The present application claims priority from Japanese application JP2005-100502 filed on Mar. 31, 2005, the content of which is hereby incorporated by reference into this application.

### BACKGROUND OF THE INVENTION

1. Field of the Invention

The present invention relates to a disk apparatus using a disk-type recording medium such as an optical disk, and a control method thereof.

2. Description of the Related Art

For example, as represented in JP-A-8-22676, the below-mentioned a disk reproducing apparatus has been proposed. In this disk reproducing apparatus, a reproduction-dedicated type optical disk is rotated/controlled in the CLV mode during the normal reproducing operation, whereas when an access operation is performed from the inner circumferential side of the optical disk to the outer circumferential side thereof, or vice versa, the optical disk is rotated/controlled in the CAV mode. As a result, the access speed during the reproducing operation can be improved in the reproduction-dedicated type optical disk where information (often referred to as “data”) has been recorded in such a recording format, the recording linear density of which is constant.

Also, as one of features owned by a disk apparatus using an optical disk, such a process operation which is so-called as a “chasing playback” is proposed. This featured process operation is performed in such a manner that while information is recorded on the optical disk, information which has already been recorded on this optical disk is reproduced. In order that this “chasing playback” can be realized, a speed of actually writing information on the optical disk by the disk apparatus is faster than a speed of transferring information which should be recorded to the disk apparatus. After the information which should be recorded is once stored in a memory employed in the disk apparatus, every certain size (amount) of the stored information are written in the optical disk in a lump so that free time duration may be produced since the disk apparatus waits such an operation that a certain amount of the information transferred to the disk apparatus are stored in the memory. While this free time duration is available, the information which has already been recorded on the optical disk is read out by the disk apparatus.

### SUMMARY OF THE INVENTION

A recording type optical disk is featured by that a large amount of information can be recorded and a medium compatibility is realized. When information is reproduced, laser light is focused on an information recording layer of this optical disk, and then, reflection light modulated by recording marks is detected. When information is recorded, recording marks are thermally formed by irradiating such a laser beam having higher power than that of reproducing laser light onto the information recording layer.

In a recording type optical disk, such a function capable of realizing an archives characteristic such as a recording capacity becomes a very important aspect rather than an access speed to recorded information and a rewritable speed which is different from a function of a magnetic information recording apparatus such as a hard disk drive. As a result, in a hard disk drive, generally speaking, information is recorded on a magnetic disk stored in this hard disk drive, while the magnetic disk is rotated/controlled in such a manner that angular velocity becomes constant (CAV: Constant Angular Velocity). In contrast, in a recording type optical disk, information is recorded, while the optical disk is rotated/controlled in such a manner that linear velocity on a disk circumferential portion becomes constant (CLV: Constant Linear Velocity) in order to increase a recording capacity per a single optical disk.

Generally speaking, in a recording type optical disk, in which a spiral-shaped track is formed from an inner circumferential portion of this optical disk to an outer circumferential portion thereof, when information is recorded on this recording type optical disk, marks and the like are thermally formed along this track. When the information is recorded on a track on the inner circumferential side of the optical disk, and when the information is recorded on a track on the outer circumferential side thereof, if a length of one information recording unit is set to be equal to each other along the track direction (namely, recording linear density becomes constant), then a large recording capacity capable of recording the information on 1 layer of an optical disk can be realized, as compared with that of such a case that a recording format used in a magnetic disk of a hard disk drive is employed.

The recording format used in the magnetic disk of the hard disk drive is realized by that when an angle with respect to an arc becomes a constant value, a length of this arc is employed as a 1 information recording unit. A length of 1 information recording unit is changed, depending upon a radial position on the magnetic disk. In other words, the further the position on the magnetic disk is close to the outer circumferential side thereof, the lower the recording density is decreased.

Generally speaking, as information rewritable recording type optical disks, very recently, phase change optical disks are known in this field. In this phase change optical disk, non-crystal marks are formed in a crystal area corresponding to a recording layer of such an optical disk by using heat generated by focused laser light, and then, information is acquired as a signal from differences of reflectance factors. Since the marks are formed by way of heat, the laser light must be irradiated by considering thermal conductions and thermal dispersion on the optical disk. In order to record marks having desirable lengths on the disk, the laser irradiating strengths and the pulse irradiation interval are controlled (will be referred to as “write strategy” hereinafter).

As a consequence, when the information is recorded on the optical disk in such a recording format that 1 information recording unit is made equal to each other irrespective of the radial position, if while optical disk is rotated/controlled in the CLV mode, the recording operation is carried out, then the same write strategy can be basically employed irrespective of the radial position. Now, such a recording operation will be referred to as a CLV recording operation in which while an optical disk is rotated/controlled in the CLV mode, information is recorded in a recording format, the recording linear density of which becomes constant.

In the case of this CLV recording operation, angular velocity of an optical disk is changed depending upon such a condition that a position of an objective lens for focusing laser onto the optical disk surface is located at which radial position on the optical disk. In other words, since the information is recorded on a track of the outer circumferential side of the optical disk, when the objective lens is present on the outer circumferential side of the optical disk, the angular velocity of the optical disk is lower than that of the optical disk on the inner circumferential side. As a consequence, in such a case that the objective lens is largely moved from the inner circumferential side of the optical disk to the outer circumferential side thereof, or vice verse, the rotation of the optical disk is controlled, and then, the information must be recorded after the angular velocity of the optical disk becomes a proper velocity value.

In the above-explained conventional technical ideas, in such a case that the disk apparatus records the information on such an optical disk suitable for recording information in a large storage capacity, the recording operation must be performed by way of the CLV recording operation in order to secure the large recording capacity, and also, the optical disk must be always rotated/controlled in such a manner that the rotation speed during the recording operation becomes constant linear velocity, depending upon such a condition that the position of the objective lens for focusing the laser light onto the optical disk surface is located at which radial position on this optical disk.

As to commercially available recording type optical disks, for example, a DVD-RAM disk, a DVD-R disk, a DVD-R disk, and a BD-RE, physical structures of these optical disks and recording formats thereof have been standardized. Accordingly, in a disk apparatus capable of accepting plural different sorts of optical disks, rotation control operations of these optical disks and position control operations of an optical head must be carried out in order to record information in accordance with the disk sorts and the adaptive recording formats.

While the disk apparatus records and rewrites data on such a rewritable optical disk as a DVD-RAM, this disk apparatus refers to a management area recorded in a certain area within this optical disk in order to grasp that where defects are present on the optical disk, and writes data after the disk apparatus recognizes that where are recordable areas on this optical disk.

Also, when the disk apparatus reads data recorded on the optical disk, records data thereon, or rewrites data, if the disk apparatus finds out a defect in recordable areas on the optical disk, then the disk apparatus updates the information of the management area and records the position of this defect area. As a result, the disk apparatus can subsequently grasp the position of this new defect area on the optical disk, and also, a position of an alternative area. Such a process operation is referred to as a “replacement procedure”, and this alternative area is called as a “spare area” hereinafter. In the case of a DVD-RAM disk, alternative areas are secured in both an inner circumferential side and an outer circumferential side of this optical disk.

While a rewritable optical disk, for example, a DVD-RAM disk is mounted in the disk apparatus, in such a case that information is recorded on this DVD-RAM disk in a recording format called as the DVD Video Recording Format under verify process operation, the optical head is moved to either the inner circumferential side or the outer circumferential side of this optical disk every time a defect is found out during the recording operation. As a result, the present rotation speed of the optical disk must be changed into such a rotation speed which is suitable for the new position of the optical head, namely, the new radial position of the object lens on the optical disk every time the defect is found out. Accordingly, since the recording operation must be interrupted until the present rotation speed (Vi) reaches to the proper rotation speed and is then stabilized, there is a problem that a lengthy time is required until all of the information which should be recorded are completed.

When the rewriting operation of the information is frequently carried out, due to the characteristic of the recording format called as “DVD Video Recording Format”, not only due to the replacement procedure by the defect, in order to record a certain amount of information, this information must be recorded on several areas which are scattered on the disk, and the radial position of the optical head on the disk is frequently changed.

As a consequence, in the case that the data is recorded on the DVD-RAM disk in the DVD Video Recording Format with the verify process operation, or in such a case that another recording operation having a similar function is combined with the above-described recording operation, a lengthy time is required in the CLV recording operation. In this case, the verify process operation owns the following meaning. That is, after information has been recorded, this recorded information is reproduced, and an error rate is monitored. When the monitored error rate is high, the recorded information is rewritten, so that a recording characteristic is kept at a level higher than an acceptable quality level.

On the other hand, while for example a DVD-R disk, or a DVD-RW disk is mounted in the disk apparatus, in such a case that information is recorded in such a recording format as the DVD Video Format, this stream information is recorded from a record starting position of the DVD-R, or DVD-RW disk along a track in a direction from the inner circumferential side to the outer circumferential side, which is similar to a so-called “writing in one stroke” manner, while the verify process operation is not carried out.

As a consequence, angular velocity of the optical disk is gradually changed in such a manner that the linear velocity is kept constant in conjunction with movement of the position of the optical head, namely, movement of the radial position of the objective lens on this optical disk from the inner circumferential side to the outer circumferential side. As a result, a lengthy time is not required in order to stabilize the rotation of the optical disk.

As previously explained in the above examples, the disk apparatus can accept the plural sorts of optical disks, but also can select the recording formats and the recording methods depending upon the sorts of information to be recorded even in one sort of optical disk. However, although the disk apparatus can accept the plural sorts of optical disks and the plural sorts of recording formats, when the information is recorded, this disk apparatus cannot select/change sorts and methods of the rotation control operations. As a result, there is another problem that a lengthy time is required in order to accomplish to record a certain amount of information.

Moreover, in the case that while information is recorded, the previously recorded information is simultaneously reproduced, the optical head must be moved to the areas which are scattered on the optical disk, so that the radial position of the optical head on the optical disk is frequently changed. As a result, the disk apparatus must be brought into the waiting state without recording, or reproducing the information until the rotation speeds of the respective radial positions become predetermined rotation speeds. Therefore, there is another problem that a lengthy time is required in order to accomplish the recording operation for a certain amount of information.

Also, in the case that a plurality of programs are substantially simultaneously recorded on different areas on an optical disk, the disk apparatus must be similarly brought into the waiting state without recording the information until the rotation speeds of the respective radial positions become predetermined rotation speeds. Therefore, there is another problem that a lengthy time is required in order to accomplish the recording operation for a certain amount of information. Even when the system described in JP-A-8-22676 is employed, this conventional system never supposes the information recording operation which requires very severe laser intensity control operation and very severe rotation control operation. Also, since this conventional system describes only such an access operation case that an access operation of the optical head is performed from the inner circumferential side to the outer circumferential side of the optical disk, or vice verse, a lengthy time is necessarily required in order to complete the recording operation as to a constant amount of information in the disk apparatus capable of accepting plural sorts of optical disks and plural kinds of recording formats.

FIG. 2 shows one example as to a series of summarized process flow operations. It shows the operations after an optical disk is mounted in this disk apparatus, or a power supply of this disk apparatus is switched from an OFF state to an ON state while the optical disk remains in the disk apparatus, and before information is actually recorded on the optical disk. In this flow chart, the optical disk apparatus recognizes that an optical disk has been mounted in the disk apparatus (step S20), and then, the disk apparatus discriminates what sort of optical disk this mounted optical disk belongs to (step S21).

If the mounted optical disk is a recordable optical disk, then the disk apparatus discriminates the sort of this recordable optical disk, namely, a write-once optical disk such as a DVD-R disk and a BD-R disk; a rewritable disk such as a DVD-RAM disk and a DVD-RW disk; or the like. After the sort of this mounted optical disk can be discriminated, the disk apparatus selects a recording format which is suitable for this disk sort, or which is defined based upon the standard, and further, sets via the system control unit 12 such a setting condition as to whether or not a verify process operation and a replacement procedure are carried out (step S22). Based upon the set conditions, the recording operation of the information is commenced (step S23).

The disk apparatus can accept the plural sorts of optical disks, and also can select the recording formats and the recording methods depending upon the sorts of information to be recorded even in one sort of optical disk. However, although the disk apparatus can accept the plural sorts of optical disks and the plural sorts of recording formats, when the information is recorded, this disk apparatus cannot select/change sorts and methods of the rotation control operations. As a result, there is another problem that a lengthy time is required in order to accomplish to record a certain amount of information.

An object of the present invention is to provide a below-mentioned disk apparatus. That is, while the disk apparatus can solve the above-explained problems and can be operated in such a case that a plurality of process operations such as a recording operation and a reproducing operation are carried out in a parallel manner, the disk apparatus is capable of quickly completing to record a certain amount of information by selecting rotation control methods which are properly adapted to these plural process operations.

The object of the present invention may be achieved by invention described in a scope of claim for a patent.

A disk apparatus, according to an aspect of the present invention, is featured by comprising a selecting/changing unit capable of selecting/changing a sort and a method of rotation control operations of a disk based upon a sort of disk mounted therein, a recording format, and a recording method, which are selected by information to be recorded. While a time duration required to stabilize a rotation of the disk is shortened, the disk apparatus records, or reproduces the information on the disk.

When handling the same sort of disks, the disk apparatus selects the sort and the method of rotation control operation which shortens the rotation stabilization time to record the information.

In accordance with the present invention, such a process operation capable of recording, or reproducing the information in the disk can be carried out in a higher efficiency.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram for indicating a system arrangement of a general-purpose disk apparatus.

FIG. 2 is a flow chart for describing recording process operations of the general-purpose disk apparatus.

FIG. 3 is a schematic block diagram for showing a system arrangement of a disk apparatus according to an embodiment of the present invention.

FIG. 4 is a flow chart for representing recording process operations of the disk apparatus according to the embodiment of the present invention.

### DESCRIPTION OF THE EMBODIMENTS

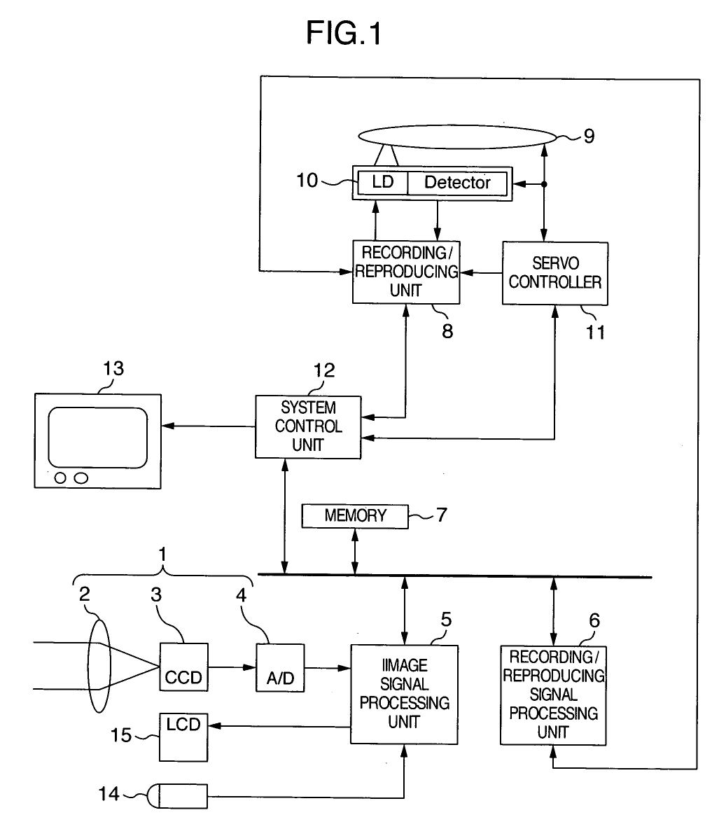

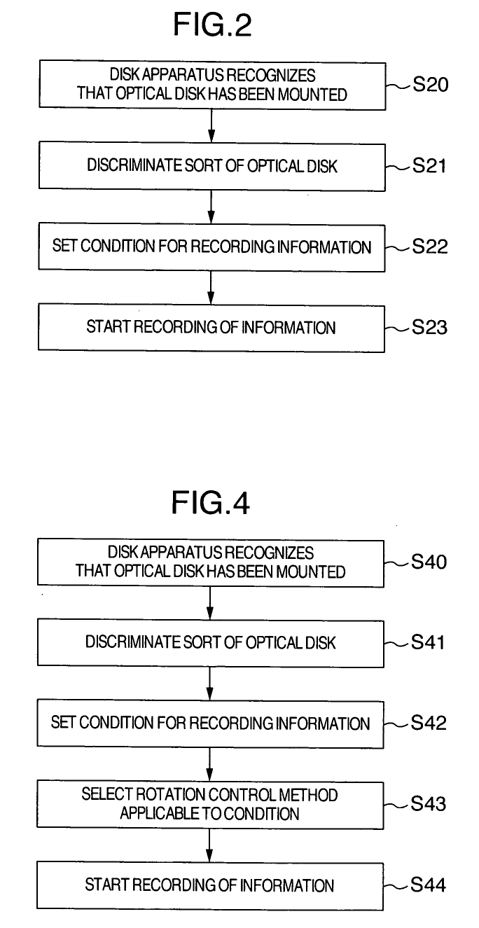

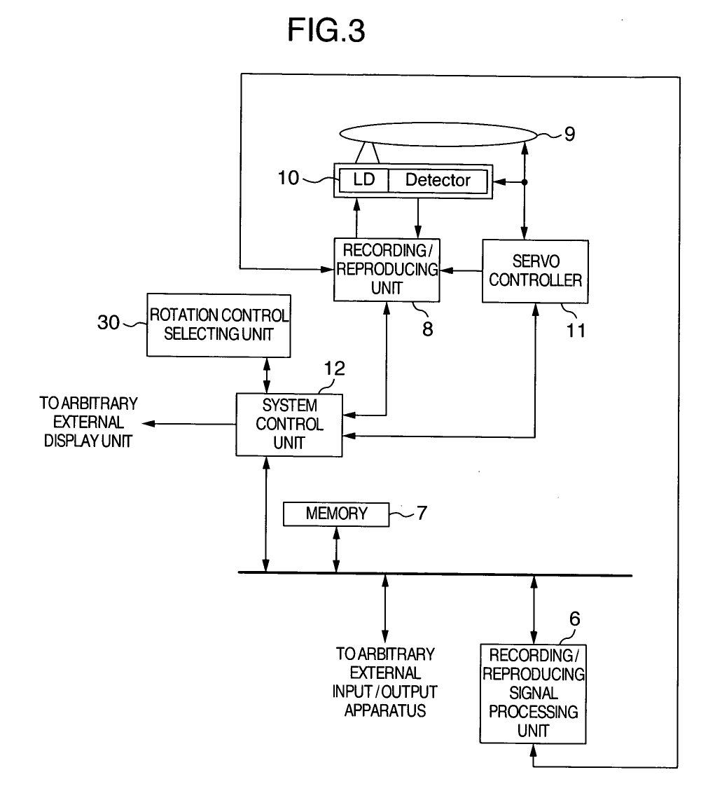

Referring now to FIG. 1, FIG. 2, FIG. 3, and FIG. 4, an embodiment of the present invention will be described.

FIG. 1 is a block diagram for schematically showing an arrangement of an apparatus example with employment of a drive apparatus.

In FIG. 1, reference numeral 1 indicates an imaging unit. The imaging unit 1 is arranged by an imaging optical system 2, a CCD (charge-coupled device: imaging element) 3, an A/D converter 4, and the like. An image of a photographic subject is focused by the imaging optical system 2 onto the CCD 3, and an image signal is acquired by the CCD 3, and then, this image signal is A/D-converted by the A/D converter 4 to output digital image data. Reference numeral 5 indicates an image signal processing unit which converts/processes the image signal derived from the imaging unit 1 into image data. It should be noted that the image signal processing unit 5 also processes a voice information signal derived from a microphone 14 which corresponds to a voice information signal input unit.

Also, during a reproducing operation, the image signal processing unit 5 converts/processes image data derived from a recording/reproducing signal process unit 6 (will be explained later) into an image information signal for a display output purpose. Furthermore, the image signal processing unit 5 converts/processes voice data derived from the recording/reproducing signal processing unit 6 into a voice information signal for voice output purpose. In the case of a video camera, both image data and voice data are processed by the image signal processing unit 5 in a continuous manner; both an image quality and a sound quality are determined based upon processing capabilities of the image signal processing unit 5; and transfer speeds of data are determined by the processing capabilities thereof, which are transferred from the image signal processing unit 5 to the recording/reproducing signal processing unit 6.

Reference numeral 6 represents a recording/reproducing signal processing unit. This recording/reproducing signal processing unit 6 performs an encode/decode process operation, a modulating/demodulating process operation, an ECC adding/error correcting process operation, and the like in order that the image data (containing also voice data) derived from the image signal processing unit 5 is converted into recording data in accordance with a recording format for recording the recording data on a disk-shaped recording medium 9, or recorded data which has been reproduced from the disk-shaped recording unit 9 is converted to image data (containing also voice data). A transfer speed of recording, or reproducing operation to the disk-type recording medium 9 is determined based upon the processing capability of the recording/reproducing signal processing unit 6, a processing capability of a recording/reproducing unit 8, the rotation speed of the disk-shaped recording medium 9, and the like.

Reference numeral 7 shows a memory which temporarily stores thereinto image data (containing also voice data) supplied from the image signal processing unit 5. The image data has been stored in the memory 7 in such a case that a transfer speed of either image data or voice data, which are transferred from the image signal processing unit 5, is faster than a speed of recording operation with respect to the disk-type recording medium 9. As a consequence, the recording operation with respect to the disk-type recording medium 9 must be carried out unless the data amount stored to the memory 7 becomes larger than, or equal to the memory storage capacity thereof.

Also, reference numeral 8 indicates a recording/reproducing unit; reference numeral 9 shows a disk-type recording medium (namely, optical disk) which is rotatably driven by a spindle motor (not shown); and reference numeral 10 represents an optical head which is constituted by a laser light source (laser diode), an optical system, a photodetector, and the like. The recording/reproducing unit 8 records the above-described recording data stored in the memory 7 on the optical disk 9 by operating the optical head 10, and also, temporarily stores the recording data reproduced from the optical disk 9 into the memory 7 by operating the optical head 10. Reference numeral 11 indicates a servo controller which is required in an optical recording operation. The servo controller 11 performs various sorts of control operations, for example, a focusing control operation and a tracking control operation by which an actuator (not shown) of the optical head 10 is controlled; a disk rotation control operation for controlling a spindle motor (not shown); a seek control operation for controlling an address position, and so on.

Reference numeral 15 indicates an image display unit constructed of an LCD (liquid crystal display) and the like. During a reproducing operation, data on the optical disk 9, which is read by the optical head 10, is processed by the recording/reproducing unit 8 and the processed data is once stored in the memory 7 as recording data which has been reproduced. Precisely speaking, the above-described data is such a data that reflection light from the optical disk 9 which is irradiated by laser light is read by the photodetector of the optical head 10 as a reflection light amount difference. Thereafter, the stored data is converted into the original image data by the recording/reproducing signal processing unit 6, and then, this original image data is displayed via the image signal processing unit 5 on this image display unit 15.

Also, reference numeral 12 shows a system control unit. The system control unit 12 is arranged by a control microcomputer which unifies/controls the entire apparatus, application software, and the like. The respective units provided in the above-described apparatus, and the entire system are unified/managed by this system control unit 12.

FIG. 3 schematically shows a disk apparatus according to an embodiment of the present invention. FIG. 3 is a schematic block diagram for indicating an arrangement of the disk apparatus using the drive apparatus of the present invention. It should be understood that the same reference numerals shown in FIG. 1 own the same functions in this drawing, and therefore, explanations thereof are omitted. Reference numeral 30 shows a rotation control selecting unit. The rotation control selecting unit 30 selects rotation control methods such as a CAV (Constant Angular Velocity) mode and a CLV (Constant Linear Velocity) mode based upon not only a sort of optical disk mounted in this disk apparatus, but also a recording format, a recording method, and the like, which are employed so as to record information on the optical disk, or based upon a combination made by an optical disk sort and a recording format, or a recording method.

In FIG. 3, although the rotation control selecting unit 30 is indicated as a separate unit with respect to the system control unit 12, the present invention is not limited only to this separate arrangement. Alternatively, the rotation control selecting unit 30 may be contained as one of the structural elements of this system control unit 12. Also, the position of the rotation control selecting unit 30 is not limited only to the present position illustrated in this block diagram. Alternatively, for example, the rotation control selecting unit 30 may be positioned between the system control unit 12 and the servo controller 11. In other words, the system control unit 12 containing the application program may transmits/receives such an information related to a selected rotation control method between the own system control unit 12 and the servo controller 11 which performs a rotation control operation.

Next, a description is made of an example as to process operations for selecting a rotation control method based upon a sort of an optical disk, a recording format, a recording method, or based upon a combination made of these conditions, depending upon such a condition as to whether or not a plurality of process operations (for example, recording process operation and reproducing process operation) are performed in a substantially parallel manner. FIG. 4 indicates one example as to a series of summarized process flow operations. It shows the operations after an optical disk is mounted in this disk apparatus, or a power supply of this disk apparatus is switched from an OFF state to an ON state while the optical disk remains in the disk apparatus and before information is actually recorded on the optical disk.

In this flow chart, the disk apparatus recognizes that an optical disk has been mounted in the own disk apparatus (step S40), and then, the disk apparatus discriminates what sort of optical disk this mounted optical disk belongs to (step S41). If the mounted optical disk is a recordable optical disk, then the disk apparatus discriminates what sort of this recordable optical disk, namely, a write-once optical disk such as a DVD-R disk and a BD-R disk; a rewritable disk such as a DVD-RAM disk and a DVD-RW disk; or the like. After the sort of this mounted optical disk can be discriminated, the disk apparatus selects a recording format which is suitable for this disk sort, or which is defined based upon the standard, and further, sets via the system control unit 12 such a setting condition as to whether or not a verify process operation and a replacement procedure are carried out (step S42).

The rotation control selecting unit 30 selects such a rotation control method capable of quickly and effectively recording a predetermined amount of information in view of a temporal aspect based upon the following selection items (step S43). These selection items may cover not only the sort of the optical disk, the recording format, and the recording method, but also such a condition of the multiplex degree of process operations as to whether or not previously recorded information is reproduced while a recording process operation is carried out, or whether or not a plurality of programs are recorded at the same time, and so on. A concrete example of this selection will be explained in detail. The recording operation of the information is commenced based upon the set condition (step S44).

A process operation for selecting an optimum rotation control method by the rotation control selecting unit 30 is carried out as follows:

That is, in the case that an optical disk mounted in the disk apparatus according to this embodiment corresponds to, for example, a DVD-RAM disk, the standard defines that information is recorded by way of such a recording format as the DVD Video Recording Format. When the system control unit 12 recognizes that the information which is recorded on the DVD-RAM disk corresponds to information whose reliability is highly required, for example, a file used in a personal computer, the system control unit 12 demands to execute a verify process operation and a replacement procedure. The above-explained verity process operation and replacement procedure are carried out even in case that an information recording disk apparatus for a general personal computer mounts a DVD-RAM disk.

Since an information recording operation is carried out based upon the DVD Video Recording Format which requires an execution of a verify process operation and a replacement procedure, an optical head is moved to either an inner circumferential side or an outer circumferential side of an optical disk every time a defect area is found out during a recording operation. Much information is frequently rewritten to the disk, with the result that, in order to record a certain amount of information, this information must be recorded on several recordable areas which are scattered on the disk. As a result, the radial portion of the optical head on the disk is frequently changed.

As a consequence, the rotation control selecting unit 30 selects the following rotation control method. That is to say, while the rotation control selecting unit 30 rotates/controls the optical disk in the CAV mode in order not to wait for a time duration until the rotation is stabilized, the information is recorded in such a recording format that recording linear density becomes constant. As a result, since the angular velocity is constant, the rotation control selecting unit 30 needs not wait for a time duration until the rotation is stabilized.

In other words, the time duration for performing the verify process operation and the replacement procedure until the rotation is stabilized is no longer required, and the process operations and the procedure can be carried out in a higher efficiency. At this time, when the disk is rotated/controlled in the CAV mode and the information is recorded in the constant recording linear density, the linear velocity itself is changed in correspondence with the radial position. As a result, the optimum recording power and the like at each of the positions must be adjusted/changed. This reason is understood from such a fact that the recording operation is carried out by applying laser light heat to such a phase change medium as a DVD-RAM disk.

Also, in the case that the system control unit 12 recognizes that information which is to be recorded on the DVD-RAM disk corresponds to the below-mentioned stream recording information such as moving picture information which is recorded by a DVD camcorder, the system control unit 12 does not demand to execute the verify process operation and the replacement procedure. As to the above-described stream recording information, it is important to continuously record a moving picture without any interruption rather than such a moving picture having a high image quality and a small number of errors. Thus, the stream recording information is recorded from a record starting position of the DVD-RAM disk along a track in a direction from the inner circumferential side to the outer circumferential side, which is similar to a so-called “writing in one stroke” manner, while the verify process operation and the replacement procedure are not carried out.

As a consequence, angular velocity of the optical disk (namely, DVD-RAM disk) is gradually changed in such a manner that the linear velocity is kept constant in conjunction with movement of the position of the optical head, namely, movement of the radial position of the objective lens on this optical disk from the inner circumferential side to the outer circumferential side. As a result, a lengthy time is not required in order to stabilize the rotation of the optical disk. Accordingly, the rotation control selecting unit 30 selects such a rotation control method that while the optical disk is rotated/controlled in the CLV mode, the information is recorded in the recording format, the recording linear density of which is constant.

Also, in such a case that the system control unit 12 recognizes that information which is to be recorded on the DVD-RAM disk corresponds to the below-mentioned information such as a TV program which is recorded by a DVD recorder, the rotation control selecting unit 30 selects such a rotation control method that while the optical disk is rotated/controlled in the CAV mode, the above-explained information is recorded in the recording format, the recording linear density of which is constant, in order not to wait for a time duration until the rotation is stabilized. As to the above-described information, the below-mentioned process operation is carried out in which while this TV program is recorded, information (program etc.) which has already been recorded on the above-described DVD-RAM disk is reproduced. This process operation will be referred to as a “chasing playback” hereinafter. As a result, while a time duration until the rotation is stabilized in order to execute the “chasing playback” is not required, the process operation can be carried out in an effective manner.

This reason is given as follows: That is, since an area “A” on the DVD-RAM disk where the information as to the TV program is presently recorded is not always located in proximity to another area “B” on the DVD-RAM disk where information has been recorded which is tried to be reproduced by the “chasing playback” manner, the radial position of the optical head must be frequently changed on the DVD-RAM disk. It should be understood that the information which is reproduced by the “chasing playback” manner may be realized by such an information which has already been recorded within information (for example, TV program) which is presently processed under recording operation. Alternatively, the information which is reproduced by the “chasing playback” manner is not limited only to the above-explained information. In other words, the information which is reproduced by the “chasing playback” manner may be realized by another information which has no relationship with the information which is presently processed under recording operation, but which has already been recorded in an area different from the above-explained areas on the DVD-RAM disk.

In this example, the “chasing playback” has been explained in which while the information is presently recorded, the information which has already been recorded is reproduced. Alternatively, another process operation may be employed in which while the information which has already been recorded is reproduced, information is newly recorded. Furthermore, such a process operation may be alternatively carried out in which while a reproducing process operation is carried out, another information which has already been recorded is reproduced. Also, as to the above-explained reproducing speed, the present invention is not limited only to a so-called “equivalent speed (1-multiple speed)” reproducing operation, but may be applied to specific reproducing operations, for example, a high speed reproducing operation, a frame-feed reproducing operation, a reverse 1-multiple reproducing operation, a reverse high speed reproducing operation, a reverse frame-feed reproducing operation, and so on. In addition, as to the recording speed, there is no specific limitation. This alternative idea may be similarly applied to the below-mentioned explanation.

Also, in such a case that the system control unit 12 recognizes that information which is to be recorded on the DVD-RAM disk corresponds to the below-mentioned information such as a plurality of TV programs which are recorded by a DVD recorder, the rotation control selecting unit 30 selects such a rotation control method that while the optical disk is rotated/controlled in the CAV mode, the above-explained information is recorded in the recording format, the recording linear density of which is constant, in order not to wait for a time duration until the rotation is stabilized. As to the above-described information, the below-mentioned process operation is carried out in which the plural TV programs are substantially simultaneously recorded in a parallel manner (will be referred to as “plural channel recording operation” hereinafter). This reason is given as follow: That is, since an area “C” on the DVD-RAM disk where information of a first TV program has been recorded is not always located in proximity to another area “D” on the DVD-RAM disk where different information from the first TV program has been recorded, the radial position of the optical head on this optical disk must be frequently changed. As a result, such a time duration until the rotation is stabilized in order to record the information on the area “D” in the parallel manner is no longer required, so that the process operation can be carried out in an effective manner.

It should also be understood that another information different from the first TV program may correspond to such an information which is completely different from the information of the first TV program, or may alternatively correspond to such a TV program having the same content and different resolution, as compared with those of the first TV program, and otherwise, may alternatively correspond to such a TV program identical to the first TV program for a back-up purpose. As apparent from the foregoing description, information which is to be recorded on the DVD-RAM disk is not limited only to information as to TV programs. When a TV program is recorded on the disk apparatus of the present invention, either one set or plural sets of TV tuners may be merely connected as one of external input/output apparatus of FIG. 3. Although only one set of the optical head 10 is illustrated in FIG. 3, plural sets of such optical heads 10 may be alternatively employed.

In this example, the description has been made in that a plurality of information are recorded at the substantially same time on the different areas of the DVD-RAM disk in the parallel manner. Also, in such a case that a plurality of information recorded on the different areas of the DVD-RAM disk are substantially simultaneously reproduced in a parallel manner, when the system control unit 12 recognizes this reproducing operation, the rotation control selecting unit 30 selects such a rotation control method that the optical disk is rotated/controlled in the CAV mode in order not to wait for a time duration until the rotation is stabilized.

Furthermore, in the case that an optical disk mounted in the disk apparatus according to this embodiment corresponds to, for example, a DVD-RW disk, the standard defines that information is recorded by way of such a recording format as the DVD Video Recording Format, or the DVD Video Format. When the system control unit 12 recognizes that the information which is recorded on the DVD-RW disk corresponds to information whose reliability is highly required, for example, a file used in a personal computer, the system control unit 12 may demand to execute a verify process operation and a quasi-replacement procedure.

Since an information recording operation is carried out based upon the DVD Video Recording Format which requires an execution of a verify process operation and a quasi-replacement procedure, an optical head is moved to either an inner circumferential side or an outer circumferential side of an optical disk when information is frequently rewritten to the disk. As a result, in order to record a certain amount of information, this information must be recorded on several recordable areas which are scattered on the disk, and the radial portion of the optical head on the disk is frequently changed.

As a consequence, the rotation control selecting unit 30 selects the following rotation control method. That is to say, while the rotation control selecting unit 30 rotates/controls the optical disk in the CAV mode in order not to wait for a time duration until the rotation is stabilized, the information is recorded in such a recording format that recording linear density becomes constant. As a result, since the angular velocity is constant, the rotation control selecting unit 30 needs not wait for a time duration until the rotation is stabilized.

At this time, the linear velocity itself is changed in correspondence with the radial position. As a result, the optimum recording power and the like at each of the positions must be adjusted/changed. This reason is understood from such a fact that the recording operation is carried out by applying laser light heat to such a phase change medium as a DVD-RW disk.

Also, in the case that the system control unit 12 recognizes that information which is to be recorded on the DVD-RW disk corresponds to the below-mentioned stream recording information such as moving picture information which is recorded by a DVD camcorder, the system control unit 12 does not demand to execute the verify process operation and the replacement procedure. As to the above-described stream recording information, it is important to continuously record a moving picture without any interruption rather than such a moving picture having a high image quality and a small number of errors. Thus, the stream recording information is recorded from a record starting position of the DVD-RW disk along a track in a direction from the inner circumferential side to the outer circumferential side, which is similar to a so-called “writing in one stroke” manner, while the verify process operation and the replacement procedure are not carried out.

As a consequence, angular velocity of the optical disk (namely, DVD-RW disk) is gradually changed in such a manner that the linear velocity is kept constant in conjunction with movement of the position of the optical head, namely, movement of the radial position of the objective lens on this optical disk from the inner circumferential side to the outer circumferential side. As a result, a lengthy time is not required in order to stabilize the rotation of the optical disk. Accordingly, the rotation control selecting unit 30 selects such a rotation control method that while the optical disk is rotated/controlled in the CLV mode, the information is recorded in the recording format, the recording linear density of which is constant.

It should also be understood that similar to the DVD-RAM disk, even in the DVD-RW disk, a so-called “chasing playback” and the plural channel recording operation may be carried out. Therefore, the rotation control selecting unit 30 selects a similar rotation control method to that of the DVD-RAM disk.

Furthermore, in the case that an optical disk mounted in the disk apparatus of the embodiment corresponds to, for instance, a DVD-R disk, the standard defines that information is recorded in such a recording format as the DVD Video Format. Since the DVD-R disk corresponds to a write-once type recording disk where only one recording operation can be carried out, when the system control unit 12 recognizes the stream recording operation, this system control unit 12 does not demand to execute the verify process operation and the replacement procedure. Thus, the stream recording information is recorded from a record starting position of the DVD-R disk along a track in a direction from the inner circumferential side to the outer circumferential side, which is similar to a so-called “writing in one stroke” manner, while the verify process operation and the replacement procedure are not carried out.

As a consequence, angular velocity of the optical disk (namely, DVD-R disk) is gradually changed in such a manner that the linear velocity is kept constant in conjunction with movement of the position of the optical head, namely, movement of the radial position of the objective lens on this optical disk from the inner circumferential side to the outer circumferential side. As a result, a lengthy time is not required in order to stabilize the rotation of the optical disk. Accordingly, the rotation control selecting unit 30 selects such a rotation control method that while the optical disk is rotated/controlled in the CLV mode, the information is recorded in the recording format, the recording linear density of which is constant.

It should also be understood that similar to the DVD-RAM disk, even in the DVD-R disk, a so-called “chasing playback” and the plural channel recording operation may be carried out. Therefore, the rotation control selecting unit 30 selects a similar rotation control method to that of the DVD-RAM disk.

The foregoing explanations have exemplified such a case that the optical disk mounted in the disk apparatus of the present embodiment corresponds to the DVD-RAM disk, the DVD-RW disk, and the DVD-R disk. However, the present invention is not limited only to these sorts of optical disks, but may employ another other optical disks if these optical disks are recording type optical disks. That is, the rotation control selecting unit 30 may similarly select proper rotation control methods which are proper to the disk sorts, and may select proper recording formats defined by the standards, and further, may select a decision as to whether or not the verify process operation and the replacement procedure are carried out, or a decision as to whether or not the “chasing playback” and the “plural channel recording operation” are carried out.

It should be further understood by those skilled in the art that although the foregoing description has been made on embodiments of the invention, the invention is not limited thereto and various changes and modifications may be made without departing from the spirit of the invention and the scope of the appended claims.

1. A disk apparatus comprising:
recording/reproducing means for optically recording information including image and/or voice on an exchangeable disk-type recording medium, or for optically reproducing information from said exchangeable disk-type recording medium; and
rotation control selecting means capable of selecting and changing a sort and a method of rotation control operation of said disk-type recording medium,
wherein, when first process operation for recording or reproducing said information on said disk-type recording medium and second process operation for recording or reproducing said information on different area from where said first process operation is being made are carried out in parallel, said rotation control selecting means selects the sort of the rotation control operation for said disk-type recording medium in said first process operation in conjunction with said second process operation.

2. A disk apparatus as claimed in claim 1 wherein:
the rotation control operation which is selected for said rotation control operation of said disk-type recording medium in said first process operation in conjunction with said second process operation is a constant angular velocity operation.

3. A disk apparatus as claimed in claim 1 wherein:
in such a case that said first process operation corresponds to a process operation for recording said information on a first area of said disk-type recording medium, and said second process operation corresponds to a process operation for reproducing said information recorded in a second area different from the first area, said sort of rotation is a rotation whose angular velocity becomes constant.

4. A disk apparatus as claimed in claim 1 wherein:
in such a case that said first process operation corresponds to a process operation for reproducing said information from a first area of said disk-type recording medium, and said second process operation corresponds to a process operation for recording said information in a second area different from the first area, said sort of rotation is a rotation whose angular velocity becomes constant.

5. A disk apparatus as claimed in claim 1 wherein:
in such a case that said first process operation corresponds to a process operation for recording said information on a first area of said disk-type recording medium, and said second process operation corresponds to a process operation for recording said information in a second area different from the first area, said sort of rotation is a rotation whose angular velocity becomes constant.

6. A disk apparatus as claimed in claim 1 wherein:
in such a case that said first process operation corresponds to a process operation for reproducing said information from a first area of said disk-type recording medium, and said second process operation corresponds to a process operation for reproducing said information recorded in a second area different from the first area, said sort of rotation is a rotation whose angular velocity becomes constant.

7. A disk recording/reproducing method in a disk apparatus equipped with recording/reproducing means for optically recording information including image and/or voice on an exchangeable disk-type recording medium, or for optically reproducing information from said exchangeable disk-type recording medium, comprising the steps of:
providing said disk apparatus with rotation control selecting means capable of selecting and changing a sort and a method of rotation control operation of an optical disk;
performing a first process operation for recording said information on a first area of said disk-type recording medium, or for reproducing said information from a first area of said disk-type recording medium; and
performing a second process operation for recording on a second area of said disk-type recording medium, the second area being different from the first area, or for reproducing from the second area in parallel with said first process operation;
selecting the sort of the rotation control operation for said disk-type recording medium in said first process operation in conjunction with said second process operation by said rotation control selecting means.

8. A disk recording/reproducing method as claimed in claim 7 wherein:
the rotation control operation which is selected for said rotation control operation of said disk-type recording medium in said first process operation in conjunction with said second process operation is a constant angular velocity operation.

9. A disk apparatus comprising:
recording/reproducing means for recording information on an exchangeable disk-type recording medium, or reproducing information from said disk-type recording medium; and
rotation control selecting means capable of selecting, or changing either a sort or a method of a rotation control operation of said disk-type recording medium,
wherein said recording/reproducing means performs;
a first process operation for recording said information on a first area of said disk-type recording medium, or for reproducing said information from a first area of said disk-type recording medium; and
a second process operation for recording said information on a second area of said disk-type recording medium or for reproducing said information from a second area in parallel with said first process operation, the second area being different from the first area,
and wherein said rotation control selecting means selects either a sort or a method of rotation control operation for said disk type recording medium in said first process operation in conjunction with said second process operation.

10. A disk apparatus comprising:
reproducing means for reproducing information from an exchangeable disk-type recording medium; and
rotation control selecting means capable of selecting, or changing either a sort or a method of rotation control operation of a disk,
wherein said reproducing means performs;
a first process operation for reproducing said information from a first area of said disk-type recording medium; and
a second process operation for reproducing said information from a second area of said disk-type recording medium, the second area being different from the first area, in parallel with said first process operation;
wherein said rotation control selecting means selects either a sort or a method of rotation control operation for said disk-type recording medium in said first process operation in conjunction with said second process operation.
